(19) United States
(12) Patent Application Publication
(10) Pub. No.: US 2012/0248381 A1
(43) Pub. Date: Oct. 4, 2012

(54) RESIN COMPOSITION AND MOLDED ARTICLE MADE OF THE SAME

(75) Inventors: Takehito SAIJO, Kyoto (JP); Hiroo KAMIKAWA, Kyoto (JP)

(73) Assignee: UNITIKA LTD., Hyogo (JP)

(21) Appl. No.: 13/428,355

(22) Filed: Mar. 23, 2012

(30) Foreign Application Priority Data
Mar. 31, 2011 (JP) 2011-076949
Feb. 8, 2012 (JP) 2012-024581

(51) Int. Cl. H01B 1/12; C08L 67/00; C08L 33/20; C08L 69/00

(52) U.S. Cl. 252/500; 525/185

(57) ABSTRACT

A resin composition of a polyarylate resin (A), a polycarbonate resin (B) and an acrylonitrile-styrene copolymer (C), wherein the mass proportions of the components simultaneously satisfy the following condition (I) and the following formula (II):

a mass proportion of (A) is 30% by mass or more (I);

(C)/[(A)+(B)+(C)]=5/100 to 30/100 (II).

### CROSS REFERENCE TO RELATED APPLICATIONS

The disclosure of Japanese Patent Application No. 2011-076949 filed Mar. 31, 2011 and Japanese Patent Application No. 2012-024581 filed Feb. 8, 2012 including specification, drawings and claims is incorporated herein by reference in its entirety.

### FIELD OF THE INVENTION

The present invention relates to a resin composition including a polyarylate resin and an acrylonitrile-styrene copolymer, or to a resin composition including a polyarylate resin, a polycarbonate resin and an acrylonitrile-styrene copolymer.

### BACKGROUND OF THE INVENTION

Polyarylate resins composed of bisphenols and aromatic carboxylic acids are widely known as engineering plastics. Polyarylate resins are excellent in heat resistance, mechanical properties and transparency, and hence molded articles made of polyarylate resins find wide application in the fields of electrical engineering, electronics, automobiles, mechanical engineering and others. However, polyarylate resins are high in melt viscosity, and hence are poor in the fluidity during molding to offer a disadvantage that the moldability is not necessarily satisfactory.

As an attempt to improve the moldability while the mechanical properties and the heat resistance of a polyarylate resin are being maintained as they are, Japanese Patent Publication No. 50-027061 and Japanese Patent Laid-Open No. 58-083050 disclose resin compositions including a polyarylate resin and a polycarbonate resin mixed therewith. These resin compositions are excellent in mechanical properties and exterior appearance and small in decrease of heat resistance, and additionally are improved in the moldability of the polyarylate resin.

However, recently automobiles and electric appliances have been reduced in weight and size, and hence the components constituting automobiles and electric appliances have also been reduced in size. In such size reduction of the components, the components strongly require thin-wall molded articles. Accordingly, the resin compositions used for obtaining such thin-wall molded articles are also strongly required to be extremely satisfactory in moldability. However, the resin compositions each including a polyarylate resin and a polycarbonate resin, described in Japanese Patent Publication No. 50-027061 and Japanese Patent Laid-Open No. 58-083050, are poor in the fluidity during molding and hence are sometimes unable to meet the required moldability.

Further, the resin compositions described in Japanese Patent Publication No. 50-027061 and Japanese Patent Laid-Open No. 58-083050 offer such disadvantages that fluidity improvers used in these compositions for the purpose of improving the fluidity of these compositions impair, for example, the visibility and the residence stability

Due to such a present situation as described above, strongly demanded are such resin compositions that are sufficiently improved in moldability (fluidity) while maintaining satisfactory mechanical properties and heat resistance of the polyarylate resin and are free from the failures such as the deficient visibility found in cases where conventional fluidity improvers are included.

### DISCLOSURE OF THE INVENTION

Accordingly, an object of the present invention is to provide a resin composition in which even when a polyarylate resin poor in the fluidity during molding is included, the moldability is improved due to the improvement of the fluidity, and further the visibility is also improved without impairing the heat resistance and the mechanical properties intrinsically possessed by the polyarylate resin.

The present inventor made a series of diligent studies for the purpose of solving the aforementioned problems, and has reached the present invention by discovering that a resin composition including a polyarylate resin (A) and an acrylonitrile-styrene copolymer (C), or a resin composition including a polyarylate resin (A), a polycarbonate resin (B) and an acrylonitrile-styrene copolymer (C) is improved in visibility and is additionally, remarkably excellent in fluidity (moldability) while the resin composition is maintaining the heat resistance and the mechanical properties such as impact resistance.

Specifically, the gist of the present invention is as follows.

(1) A resin composition comprising a polyarylate resin (A), a polycarbonate resin (B) and an acrylonitrile-styrene copolymer (C), wherein the mass proportions of the components simultaneously satisfy the following condition (I) and the following formula (II):

In a resin composition including (A) and (B), the mass proportion of (A) is 30% by mass or more. (I)

(C)/[(A)+(B)+(C)]=5/100 to 30/100 (II)

(2) A resin composition comprising the polyarylate resin (A) and the acrylonitrile-styrene copolymer (C), wherein the mass proportions of the components satisfy the following formula (III):

(C)/[(A)+(C)]=5/100 to 30/100 (III)

(3) The resin composition according to (1) or (2), the copolymerization ratio of the acrylonitrile-styrene copolymer (C) falls in terms of molar ratio within a range of acrylonitrile/styrene=15/85 to 35/65.

(4) The resin composition according to (1) or (3), wherein the inherent viscosity of the polycarbonate resin (B) is 0.3 to 0.7 dl/g.

(5) The resin composition according to (1) or (2), wherein the inherent viscosity of the acrylonitrile-styrene copolymer (C) is 0.4 to 1.0 dl/g.

(6) The resin composition according to (1) or (2), further including a conductive substance.

(7) A molded article comprising the resin composition according to any one of (1) to (6).

According to the present invention, the inclusion of an acrylonitrile-styrene copolymer enables the improvement of the fluidity (moldability) of the polyarylate resin while the heat resistance, the mechanical properties and the residence stability of the polyarylate resin are being maintained at the practically required levels.

Further, according to the present invention, the decrease of the flow length in the case where a molded article is thin-walled is small, and the visibility is improved; accordingly the resin composition of the present invention is extremely useful.

Additionally, when the resin composition of the present invention includes a polycarbonate resin in addition to a polyarylate resin and an acrylonitrile-styrene copolymer, the mechanical properties of the polyarylate resin can be improved and the moldability of the polyarylate resin can be more improved.

When the resin composition of the present invention includes a conductive substance, the electromagnetic wave shielding property of the resin composition can be improved concomitantly with the improvement of the fluidity of the resin composition.

### DESCRIPTION OF THE EMBODIMENTS

Hereinafter, the present invention is described.

The resin composition of the present invention is a resin composition including a polyarylate resin (A) and an acrylonitrile-styrene copolymer (C), or a resin composition including a polyarylate resin (A) and a polycarbonate resin (B) and further including an acrylonitrile-styrene copolymer (C).

In the present invention, a polyarylate resin (A) means a polyester constituted of aromatic dicarboxylic acid residues and residues of bisphenols. The polyarylate resin (A) can be produced by a heretofore known, conventional method such as melt polymerization or interface polymerization.

Specific examples of the aromatic dicarboxylic acid include: terephthalic acid, isophthalic acid, phthalic acid, 2,5-naphthalene dicarboxylic acid, 2,6-naphthalene dicarboxylic acid, 2,7-naphthalene dicarboxylic acid, 1,5-naphthalene dicarboxylic acid, methylterephthalic acid, 4,4′-biphenyl dicarboxylic acid, 2,2′-biphenyl dicarboxylic acid, 4,4′-biphenylether dicarboxylic acid, 4,4′-diphenylmethane dicarboxylic acid, 4,4′-diphenylsulfone dicarboxylic acid, 4,4′-diphenylisopropylidene dicarboxylic acid, 1,2-bis(4-carboxyphenoxy)ethane and 5-sodium sulfoisophthalic acid.

Among the aforementioned examples, terephthalic acid and isophthalic acid are preferable as the aromatic dicarboxylic acid, and it is particularly preferable to use a mixture of these two acids, from the viewpoint of the melt workability and mechanical properties.

The molar ratio between terephthalic acid and isophthalic acid (terephthalic acid/isophthalic acid) is optional within a range from 100/0 to 0/100. In particular, the molar ratio is preferably 70/30 to 30/70 and more preferably 60/40 to 40/60, from the viewpoint of the melt workability, mechanical properties and polymerizability, and the discoloration resistance of the obtained polyarylate resin.

Within the molar ratio between terephthalic acid and isophthalic acid, it is preferable to use isophthalic acid in excess over terephthalic acid for the purpose of improving the discoloration resistance against light (in particular, ultraviolet light). Alternatively, it is preferable to use terephthalic acid in excess over isophthalic acid for the purpose of improving the heat resistance.

Examples of the bisphenols include: 2,2-bis(4-hydroxyphenyl)propane (bisphenol A), 2,2-bis(4-hydroxy-3,5-dimethylphenyl)propane, 2,2-bis(4-hydroxy-3,5-dibromophenyl)propane, 2,2-bis(4-hydroxy-3,5-dichlorophenyl)propane, 4,4′-dihydroxydiphenyl sulfone, 4,4′-dihydroxydiphenyl ether, 4,4′-dihydroxydiphenyl sulfide, 4,4′-dihydroxydiphenyl ketone, 4,4′-dihydroxydiphenylmethane, 1,1-bis(4-hydroxyphenyl)cyclohexane, 1,1-bis(4-hydroxyphenyl)-3,3,5-trimethylcyclohexane (bisphenol TMC) and 2-phenyl-3,3-bis(4-hydroxyphenyl)phthalimidine (PPPBP). These bisphenols may be used each alone or as mixtures of two or more thereof.

Among the aforementioned bisphenols, 2,2-bis(4-hydroxyphenyl)propane is preferably used from the viewpoint of cost performance and polymerizability. Alternatively, bisphenol TMC and PPPBP are preferably used from the viewpoint of heat resistance.

The inherent viscosity of the polyarylate resin (A) falls within a range preferably from 0.3 to 1.0 dl/g, more preferably from 0.35 to 0.7 dl/g, furthermore preferably from 0.38 to 0.6 dl/g and particularly preferably from 0.40 to 0.55 dl/g.

When the inherent viscosity of the polyarylate resin (A) is less than 0.3 dl/g, the obtained resin composition is low in molecular weight, and hence is sometimes poor in mechanical properties and heat resistance. Conversely, when the inherent viscosity of the polyarylate resin (A) exceeds 1.0 dl/g, the obtained resin composition is high in melt viscosity, and hence sometimes undergoes discoloration and fluidity decrease during melt processing. The inherent viscosity as referred to in the present invention means a value measured with a solution set at a temperature of 25° C., the solution being prepared by dissolving 1.0 g of a sample in 100 ml of 1,1,2,2-tetrachloroethane.

The polycarbonate resin (B) as referred to in the present invention is a resin constituted of residues of bisphenols and carbonate residues. The polycarbonate resin (B) comprises residues of bisphenols similar to the polyarylate resin (A), and hence exhibits a satisfactory compatibility with the polyarylate resin (A). Moreover, mixing of the polycarbonate resin (B) with the polyarylate resin (A) provides an advantage that the moldability, heat resistance and impact resistance of the polyarylate (A) are improved. In the present invention, even when the polycarbonate resin (B) is not included, the intended effects can sometimes be achieved.

Examples of the bisphenols include: 2,2-bis(4-hydroxyphenyl)propane, 2,2-bis(3,5-dibromo-4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)decane, 1,4-bis(4-hydroxyphenyl)propane, 1,1-bis(4-hydroxyphenyl)cyclododecane, 4,4′-dihydroxydiphenyl ether, 4,4′-dithiodiphenol, 4,4′-dihydroxy-3,3′-dichlorodiphenyl ether and 4,4′-dihydroxy-2,5-dihydroxydiphenyl ether.

As the bisphenols, in addition to the listed above, for example, the diphenols described in U.S. Pat. Nos. 2,999,835, 3,028,365, 3,334,154 and 4,131,575 can also be used. These bisphenols may be used each alone or as mixtures of two or more thereof.

Among these bisphenols, 2,2-bis(4-hydroxyphenyl)propane is preferably used, and 2,2-bis(4-hydroxyphenyl)propane is most preferably used alone from the viewpoint of cost performance.

Examples of the component for introducing the carbonate residue include phosgene and diphenyl carbonate.

In the present invention, the aforementioned inherent viscosity of the polycarbonate resin (B) is preferably 0.3 to 7 dl/g and more preferably 0.35 to 0.65 dl/g. When the inherent viscosity of the polycarbonate resin (B) is less than 0.3 dl/g, the obtained resin composition is sometimes poor in mechanical properties and heat resistance. On the other hand, when the inherent viscosity of the polycarbonate resin (B) exceeds 0.7 dl/g, the obtained resin composition is high in melt viscosity, and hence sometimes undergoes discoloration and fluidity decrease during melt processing.

In the resin composition of the present invention, in the case where the polycarbonate resin (B) is included, the content proportions of the polyarylate resin (A) and the polycarbonate resin (B) are required to satisfy the following condition (I) in terms of mass proportion, from the viewpoint of the heat resistance and the mechanical properties of the obtained resin composition:

In a resin composition including (A) and (B), the mass proportion of (A) is 30% by mass or more. (I)

Moreover, in the case where the polycarbonate resin (B) is included, the ratio (A)/(B) is preferably 40/60 to 90/10 in terms of mass ratio. When the proportion of the polyarylate resin (A) is less than 30% by mass in terms of the mass ratio, no sufficient heat resistance and no sufficient mechanical properties are sometimes obtained.

In the present invention, the use of the acrylonitrile-styrene copolymer (C) allows the effect of remarkable improvement of the fluidity to be developed while maintaining the satisfactory heat resistance and mechanical properties of the polyarylate resin. In other words, the acrylonitrile-styrene copolymer (C) acts as a fluidity improver.

Moreover, the use of the acrylonitrile-styrene copolymer (C) offers advantages of obtaining a resin composition small in flow length decrease in thinning of wall thickness in molded articles, and free from in-use failures such as water absorption or the residence degradation during molding. Additionally, the use of the acrylonitrile-styrene copolymer (C) also offers an advantage of remarkably improving the visibility of the obtained resin composition.

In this connection, it is anticipated that even in the case where a methyl methacrylate-styrene copolymer, a fluidity improver, is used as the fluidity improver for the polyarylate resin, the effects similar to the effects found in the resin compositions including the acrylonitrile-styrene copolymer (C) are obtained. However, the use of the acrylonitrile-styrene copolymer (C) yields a resin composition higher in the effect of improving the fluidity. Additionally, the use of the acrylonitrile-styrene copolymer (C) achieves a higher effect of suppressing the molding flash during injection molding and also an effect of enabling to obtain a resin composition more enhanced in the effect of improving the moldability, as compared to the use of the methyl methacrylate-styrene copolymer.

The acrylonitrile-styrene copolymer (C) used in the present invention is a copolymer composed of an acrylonitrile unit and a styrene unit. The acrylonitrile-styrene copolymer (C) can be obtained with a heretofore known polymerization method. Examples of such a polymerization method include bulk polymerization, solution polymerization, suspension polymerization and emulsion polymerization.

The weight average molecular weight of the acrylonitrile-styrene copolymer (C) is not particularly limited; however, from the viewpoint of the balance between the mechanical properties and the moldability, the weight average molecular weight of the acrylonitrile-styrene copolymer (C) is preferably 30000 to 250000 and more preferably 50000 to 200000.

The glass transition temperature as measured with the differential scanning calorimetric method (DSC method) of the acrylonitrile-styrene copolymer (C) used in the present invention is preferably 75 to 110° C. and more preferably 80 to 100° C., from the viewpoint of the balance between the heat resistance and the fluidity of the obtained resin composition. When the glass transition temperature of the acrylonitrile-styrene copolymer (C) is lower than 75° C., the heat resistance of the obtained resin composition is sometimes decreased. On the other hand, when the glass transition temperature of the acrylonitrile-styrene copolymer (C) exceeds 110° C., the fluidity of the resin composition is sometimes decreased.

The inherent viscosity of the acrylonitrile-styrene copolymer (C) is preferably 0.4 to 1.0 dl/g, more preferably 0.45 to 0.9 dl/g and furthermore preferably 0.45 to 0.8 dl/g. When the inherent viscosity of the acrylonitrile-styrene copolymer (C) is less than 0.4 dl/g, the melt viscosity difference between the acrylonitrile-styrene copolymer (C) and the polyarylate resin is too large in the obtained resin composition, and hence the exterior appearance during molding is sometimes degraded. On the other hand, when the inherent viscosity of the acrylonitrile-styrene copolymer (C) exceeds 1.0 dl/g, no sufficient fluidity improvement effect is sometimes obtained in the production of molded articles from the obtained resin composition.

As the acrylonitrile-styrene copolymer (C) used in the present invention, commercially available products can also be suitably used. Examples of such usable commercially available products include “UMG AXS Resin Series (trade name)” manufactured by UMG ABS, Ltd.

The copolymerization ratio between acrylonitrile and styrene in the structure of the acrylonitrile-styrene copolymer (C) falls, in terms of molar ratio, within a range preferably from acrylonitrile/styrene=15/85 to 35/65, more preferably from 18/82 to 32/68 and furthermore preferably from 20/80 to 30/70. When the molar proportion of acrylonitrile exceeds 35% by mass, no sufficient residence stability and moldability during molding are sometimes obtained in the obtained resin composition. On the other hand, when the molar proportion of styrene exceeds 85% by mass, failure in exterior appearance such as exfoliation is sometimes caused during high-temperature treatment in the production of molded articles from the obtained resin composition.

In the present invention, the mass proportions of the acrylonitrile-styrene copolymer (C), the polyarylate resin (A) and the polycarbonate resin (B) are required to satisfy the relation of the following formula (II):

(C)/[(A)+(B)+(C)]=5/100 to 30/100 (II)

The foregoing formula (II) represents the content proportion of the acrylonitrile-styrene copolymer (C) in relation to 100 parts by mass of the total content of the polyarylate resin (A), polycarbonate resin (B) and acrylonitrile-styrene copolymer (C).

However, the present invention sometimes allows a case where the polycarbonate resin (B) is not included. In the case where the polycarbonate resin (B) is not included, the mass proportions of the polyarylate resin (A) and the acrylonitrile-styrene copolymer (C) are required to satisfy the relation of the following formula (III):

(C)/[(A)+(C)]=5/100 to 30/100 (III)

In the present invention, in relation to 100 parts by mass of [(A)+(B)+(C)] or in relation to 100 parts by mass of [(A)+(C)], the amount of the acrylonitrile-styrene copolymer (C) is required to be 5 to 30 parts by mass and is preferably 6 to 28 parts by mass, and is more preferably 7.5 to 25 parts by mass from the viewpoint of moldability. When the content proportion of the acrylonitrile-styrene copolymer (C) is less than 5 parts by mass, the improvement of the moldability of the obtained resin composition, based on the fluidity improvement effect, is scarcely achieved. In the production of molded articles from the obtained resin composition, the larger the content of the acrylonitrile-styrene copolymer (C) is, the smaller is the decrease of the flow length in the case where molded articles are thin-walled. However, when the content of the acrylonitrile-styrene copolymer (C) exceeds 30 parts by mass, the heat resistance and the mechanical properties are degraded.

When 25 parts by mass or more of the acrylonitrile-styrene copolymer (C) is used in relation to 100 parts by mass of [(A)+(B)+(C)] or in relation to 100 parts by mass of [(A)+(C)], the mixing proportions of the polyarylate resin (A) and the polycarbonate resin (B) are, in terms of the mass ratio, (A)/(B)=30/70 to 90/10 and more preferably (A)/(B)=30/70 to 80/20, for the purpose of not impairing the mechanical properties and the heat resistance of the resin composition.

In the case where 25 parts by mass or more of the acrylonitrile-styrene copolymer (C) is used, when the proportion of the polyarylate resin (A) is less than 30% by mass, sufficient heat resistance tends to be hardly obtained. On the other hand, when the proportion of the polyarylate resin (A) exceeds 90% by mass, sufficient mechanical properties tend to be hardly obtained.

In such a case as described above, the proportion of the polyarylate resin (A) exceeding 90% by mass makes it difficult to obtain sufficient mechanical properties. The reasons for this are not clear; however, the reasons are inferred as follows. Specifically, when 25 parts by mass or more of the acrylonitrile-styrene copolymer (C) is used, in particular the fluidity of the resin composition tends to be remarkably improved. On the other hand, the acrylonitrile-styrene copolymer (C) is relatively lower in melt viscosity than the polyarylate resin (A), hence the melt viscosity of the resin composition tends to be decreased, and it is thus made difficult to mix the resin composition during melt-kneading under sufficient shear force to result in insufficiently uniform mixing of the resin composition. Consequently, probably the satisfactory mechanical properties of the polyarylate resin and the polycarbonate resin are not sufficiently reflected in the obtained resin composition.

In the present invention, simultaneously specification of the inherent viscosity of the acrylonitrile-styrene copolymer (C) and the content of the acrylonitrile-styrene copolymer (C) in the resin composition so as to fall respectively within the aforementioned ranges achieves the effect of capable of enhancing the melt viscosity property of the obtained resin composition. In other words, the simultaneous specification of both of these quantities enables to improve the fluidity of the resin composition when the resin composition is melted and allowed to flow. On the other hand, the simultaneous specification also enables to rapidly stop the flow of the molten resin composition when the filling of the mold with the molten resin composition is completed. Consequently, in the injection molding of the resin composition, the protrusion of the resin composition from the mold gap can be suppressed, and the quality degradation of the molded article caused by the generation of the molding flash can be prevented.

The reasons for the capability of suppressing the generation of the molding flash are not clear; however, the reasons are inferred to be based on the following phenomenon. Specifically, the resin composition of the present invention has such a melt viscosity property that the responsiveness of the melt viscosity variation of the molten resin against the shear velocity during injection molding is extremely satisfactory. In other words, the resin composition of the present invention has such a property that the responsiveness of the melt viscosity variation of the molten resin against the shear velocity during injection molding is satisfactory. Specifically, immediately after the injection of the resin composition of the present invention, the shear velocity given to the molten resin is fast, and hence the molten resin flows with a satisfactory responsiveness. On the other hand, on completion of the filling of the mold with the molten resin, the shear velocity given to the molten resin is slow, and hence the flow of the molten resin is stopped with a satisfactory responsiveness. Consequently, the protrusion (molding flash) of the resin composition from the mold gap can be efficiently suppressed.

In general, the molding flash generated in molded articles not only degrades the quality of the molded articles but also disturbs the mutual fitting of parts in assembling a plurality of molded articles. Accordingly, where necessary, the generated molding flash is required to be cut away with a knife. However, the resin composition of the present invention is capable of efficiently suppressing the generation of mold flash itself, and hence no time and effort are needed for performing such a step of removing the molding flash, and thus the handleability is improved. The melt viscosity property (the responsiveness of the melt viscosity variation of the molten resin against the shear velocity during injection molding) in the present invention is different from the thixotropy (the variation property of the viscosity with time against the stirring time), and is a phenomenon in which the melt viscosity property varies independently of time.

Moreover, the resin composition of the present invention develops such melt viscosity property as aforementioned, and hence the resin composition is inferred to possess the following morphology. Specifically, as compared to the melt viscosity of the polyarylate resin (A) and the melt viscosity of the polycarbonate resin (B), the melt viscosity of the acrylonitrile-styrene copolymer (C) used in the present invention is relatively smaller. Accordingly, when the resin composition is formed, in the resin composition, a network-shaped sea-island structure in which the polyarylate resin (A) and the polycarbonate resin (B) each form an island structure, and the acrylonitrile-styrene copolymer (C) component forms a sea-island continuous layer or a sea component. Consequently, the resin composition can efficiently reduce the shear stress between the mold and the molten resin, and hence has an excellent melt viscosity property.

When a shear force is applied, as compared to the shear velocity of the polyarylate resin (A) and the shear velocity of the polycarbonate resin (B) during melting, the shear velocity of the acrylonitrile-styrene copolymer (C) during melting varies more rapidly, and consequently, the fluidity of the acrylonitrile-styrene copolymer (c) tends to be improved. Accordingly, in addition to the effect of the reduction of the shear stress between the mold and the molten resin, the fluidity improvement effect of the resin composition can be enhanced.

The resin composition of the present invention has such a melt viscosity property as aforementioned, and hence thick-wall molded articles can be easily molded from the resin composition, and additionally, the fluidity can be ensured even during molding of thin-wall molded articles. Moreover, by taking advantage of the heat resistance of the polyarylate resin (A) and the heat resistance of the polycarbonate resin (B), it is possible to perform a high-temperature metal-mold molding at temperatures exceeding the glass transition temperature of the acrylonitrile-styrene copolymer (C), and hence the acrylonitrile-styrene copolymer (C) in the resin composition is solidified slowly, to make it difficult for the gate seal to occur. Consequently, it is possible to reduce the sinks by sufficiently bringing dwelling pressure into action. Further, a vapor deposition process can be applied to the molded articles while transferability of the mold shape is being enhanced.

As described above, the resin composition of the present invention exhibits an extremely high fluidity. However, the difference between the melt viscosity of the resin composition including the polyarylate resin (A) and the polycarbonate resin (B) and the melt viscosity of the acrylonitrile-styrene copolymer (C) is extremely large, and hence the fluidity of the resin composition is sometimes increased more than necessary. In the case where the injection molding is performed by using such a resin composition extremely high in fluidity, the obtained molded article sometimes undergoes surface roughening around the gate. Examples of the method for overcoming such surface roughening include: a method in which a polyarylate resin or a polycarbonate resin comparatively low in viscosity is selected; a method in which an acrylonitrile-styrene copolymer comparatively high in viscosity is selected; and a method in which the mixing amount of the acrylonitrile-styrene copolymer is not excessively increased.

The resin composition of the present invention may further include a conductive substance (a substance having conductivity). The inclusion of a conductive substance achieves an effect of being capable of imparting electromagnetic wave shielding property to the resin composition while the fluidity is being ensured. The strength of the obtained resin composition can also be improved. The resin composition in which the electromagnetic wave shielding property is improved is suitably used for the molded articles constituting electric automobiles and electric parts.

Examples of the conductive substance include graphite particles, carbon black, carbon fiber, and a powder prepared by coating the surface of barium sulfate with tin oxide and antimony oxide. Among these conductive substances, the powder prepared by coating the surface of barium sulfate with tin oxide and antimony oxide is preferably used for the purpose of ensuring the fluidity and imparting the electromagnetic wave shielding property while making the most of the visibility featuring the present invention. Barium sulfate has a refractive index of as low as about 1.64 and facilitates the acquirement of the visibility in the resin composition prepared by including barium sulfate. In the applications requiring no visibility as the molded articles imparted with electromagnetic wave shielding property by the conductive substance, in particular graphite particles, carbon black and carbon fiber can also be used. The inclusion of graphite particles, carbon black or carbon fiber even in a small amount blackens the resin composition to disturb the ensuring of the visibility; however, the inclusion of such a conductive substance does not impair the fluidity of the resin composition, and hence enables to impart electromagnetic wave shielding property to the resin composition while the fluidity is being ensured.

Graphite particles are not particularly limited; either artificial graphite or natural graphite may be adopted. Specific examples of graphite include: natural flake graphite, spherical graphite, block graphite, expanded graphite and kish graphite. Preferable among these is spherical graphite because spherical graphite is excellent in strength, rigidity and impact resistance. Graphite particles may be used as one type alone or may be used as mixtures of two or more types.

As spherical graphite, commercially available spherical graphites can also be suitably used. Specific examples of commercially available graphites include the spherical graphite manufactured by Nippon Graphite Industries, Ltd. In the present invention, spherical graphite, block graphite and flake graphite may also be used in combination within the ranges not impairing the advantageous effects of the present invention.

The average particle size (median size) of the graphite particles is preferably 10 to 200 μm, more preferably 15 to 100 μm and furthermore preferably 20 to 80 μm. The average particle size of the graphite particles less than 10 μm sometimes results in poor electromagnetic wave shielding property. On the other hand, the average particle size of the graphite particles exceeding 200 μm results in a tendency to be poor in strength and impact resistance, and additionally, the exterior appearance of obtained molded articles is sometimes impaired.

When graphite particles are used as a conductive substance, the content of the graphite particles in the resin composition is preferably 10 to 80 parts by mass, more preferably 15 to 70 parts by mass and furthermore preferably 20 to 60 parts by mass in relation to 100 parts by mass of the resin composition. When the content of the graphite particles is less than 10 parts by mass, it is sometimes difficult to impart electromagnetic wave shielding property. On the other hand, when the content of the graphite particles exceeds 80 parts by mass, kneading is made difficult and it is sometimes made difficult to obtain a resin composition in which graphite particles are uniformly dispersed.

Carbon fiber is not particularly limited; however, examples of carbon fiber include a polyacrylonitrile-based (PAN-based) carbon fiber and a pitch-based carbon fiber high in strength and conductivity. Among these, the PAN-based carbon fiber is preferably used because of high effect of reinforcing the strength and rigidity of the obtained molded articles.

The fiber length of the carbon fiber is preferably 0.1 to 7 mm and more preferably 0.5 to 6 mm. When the fiber length is less than 0.1 mm, the reinforcing effect and the imparting of the electromagnetic wave shielding property are sometimes insufficient. On the other hand, when the fiber length exceeds 7 mm, the moldability in molding of the obtained resin composition is adversely affected.

The fiber diameter of the carbon fiber is preferably 5 to 13 μm and more preferably 6 to 10 μm. When the fiber diameter is less than 5 μm, the strength of the molded article is sometimes not sufficiently improved. On the other hand, when the fiber diameter exceeds 13 μm, the reinforcing effect and the imparting of the electromagnetic wave shielding property are sometimes insufficient.

When carbon fiber is used as the conductive substance, the content of the carbon fiber in the resin composition is preferably 10 to 50 parts by mass, more preferably 15 to 45 parts by mass and furthermore preferably 20 to 40 parts by mass in relation to 100 parts by mass of the resin composition. When the content of the carbon fiber is less than 10 parts by mass, the strength, rigidity, impact resistance and electromagnetic wave shielding property are sometimes insufficiently imparted to the obtained molded articles. On the other hand, when the content of the carbon fiber exceeds 50 parts by mass, kneading is made difficult and even if a resin composition is obtained, the strength of the molded articles is degraded, and moreover, the impact resistance and the exterior appearance of the molded articles are sometimes poor.

The average particle size of the powder prepared by coating the surface of barium sulfate with tin oxide and antimony oxide is preferably 0.01 to 2.0 μm and more preferably 0.1 to 0.4 μm. The average particle size of the powder falling within a range from 0.01 to 2.0 μm facilitates the ensuring of the visibility. In the powder, the thickness values of the coating films of tin oxide and antimony oxide coated on the surface of barium sulfate are preferably 1 to 30 nm and more preferably 5.0 to 12.0 nm.

When the powder prepared by coating the surface of barium sulfate with tin oxide and antimony oxide is used as the conductive substance, the content of the powder prepared by coating the surface of barium sulfate with tin oxide and antimony oxide in the resin composition is preferably 5 to 100 parts by mass, more preferably 10 to 90 parts by mass and furthermore preferably 20 to 80 parts by mass in relation to 100 parts by mass of the resin composition. When the content of the powder prepared by coating the surface of barium sulfate with tin oxide and antimony oxide is less than 5 parts by mass, the imparting of the electromagnetic wave shielding property is sometimes insufficient. On the other hand, when the content of the powder exceeds 100 parts by mass, the ensuring of the visibility is sometimes made difficult.

In the present invention, when carbon fiber and graphite particles are used as conductive substances, the aforementioned content of the carbon fiber and the aforementioned content of the graphite particles preferably satisfy the aforementioned ranges, respectively, and at the same time, the sum of the content of the carbon fiber and the content of the graphite particles more preferably falls within a specific range. Specifically, the sum of the content of the carbon fiber and the content of the graphite particles is preferably 30 to 100 parts by mass, more preferably 35 to 90 parts by mass and furthermore preferably 40 to 80 parts by mass in relation to 100 parts by mass of the resin composition. When the sum of the content of the carbon fiber and the content of the graphite particles is less than 30 parts by mass, the imparting of the strength, rigidity, impact resistance and electromagnetic wave shielding property is sometimes insufficient. On the other hand, when the sum of the content of the carbon fiber and the content of the graphite particles exceeds 100 parts by mass, kneading is made difficult, and hence it is impossible to easily obtain a resin composition in which the carbon fiber and the graphite particles are uniformly dispersed, to result in poor productivity.

The resin composition of the present invention may include an organic lubricant in addition to the conductive substance. The inclusion of an organic lubricant improves the uniform dispersion of the conductive substance in the resin composition and enables to improve the operability, in the case where the conductive substance is mixed in the resin composition. Additionally, the inclusion of an organic lubricant also enables to impart electromagnetic wave shielding property, without impairing the fluidity of the obtained resin composition.

Examples of the organic lubricant include: fatty acid amides such as ethylene bis-stearyl amide; and alkylene-bis fatty acid amides such as erucic acid amide.

Within the ranges not impairing the advantageous effects of the present invention, the resin composition of the present invention may include, for example, phosphite compounds, phenolic compounds, benzotriazole compounds, triazine compounds, hindered amine compounds, sulfur compounds or mixtures of these compounds, from the viewpoint of the stability with respect to heat or light, in addition to the aforementioned polyarylate resin (A), polycarbonate resin (B), acrylonitrile-styrene copolymer (C), conductive substance and organic lubricant.

Within the ranges not impairing the advantageous effects of the present invention, the resin composition of the present invention may include additives other than the aforementioned additives, such as an antioxidant, an ultraviolet absorber, a bluing agent, a pigment, a flame retardant, a release agent, an antistatic agent, a lubricant, an organic filler and an inorganic filler.

In the present invention, the method for obtaining a resin composition including the polyarylate resin (A) and the acrylonitrile-styrene copolymer (C), or a method for obtaining a resin composition including the polyarylate resin (A), the polycarbonate resin (B) and the acrylonitrile-styrene copolymer (C) is not particularly limited; it is only required to achieve the condition that the respective components are uniformly dispersed.

Specifically, examples of such a method include a method in which the respective components are uniformly dry blended with a tumbler or a Henschel mixer, then the resulting mixture is melt-kneaded and extruded to yield a melt-kneaded mixture, and subsequently the obtained melt-kneaded mixture is subjected to the steps of cooling, cutting and drying to be pelletized.

In the melt kneading, a common kneading machine such as a single screw extruder, a double screw extruder, a roll kneading machine or a Brabender kneader can be used. Among these, a double screw extruder is preferably used from the viewpoint of improving the dispersibility.

The resin composition of the present invention can be molded into various types of molded articles with any methods. The molding method is not particularly limited, and the method such as an injection molding method, an extrusion method, a compression molding method and a blow molding method can be applied.

Hereinafter, the present invention is described more specifically with reference to Examples. The present invention is not limited to these Examples.

In what follows, the evaluation methods implemented in Examples and Comparative Examples are described.

It is to be noted that in the present specification, the “base resin composition” means a resin composition in which the content ratio (A)/(B) is the same as the content ratio (A)/(B) in the resin composition including [(A)+(B)+(C)], and (C) is not included. The base resin composition also includes the case where the content of (B) is 0 part by mass. For example, the resin compositions of Comparative Examples 1 and 2 correspond to the base resin compositions of Examples 1 and 2, respectively.

(1) Inherent Viscosity (dl/g)

The inherent viscosity was measured according to ISO 1628-1. Specifically, the inherent viscosity of a sample solution was measured at a temperature of 25° C. with a Ubbelohde viscosity tube wherein the sample solution was prepared by using 1,1,2,2-tetrachloroethane as a solvent and by adding 1 g of a sample to 100 ml of the solvent (in other words, the concentration of the solution was set at 1 g/dl).

(2) Bar Flow Length (mm)

The pellet-shaped resin composition obtained in each of Examples and Comparative Examples was hot air dried at 120° C. for 12 hours or more. The flow length of a specimen was measured as the bar flow length when the molding was performed with an injection molding machine (trade name: S2000i-100B, manufactured by FANUC Corp.) at a cylinder temperature set at 320° C., a mold temperature set at 120° C., an injection pressure of 120 MPa, an injection time of 4 seconds and an injection speed set at 100 mm/sec. The bar flow length is to be an index for fluidity. The following molds were used: for the measurement with a 2-mm thick specimen, a bar flow test mold of 2 mmt in thickness, 20 mm in width and 980 mm in length was used; for the measurement with a 1-mm thick specimen, a bar flow test mold of 1 mmt in thickness, 20 mm in width and 330 mm in length was used.

(3) Deflection Temperature Under Load (° C.)

The deflection temperature under load was measured according to ISO 75-1, with a 4-mm thick specimen under a load of 1.8 MPa. Before the measurement of the deflection temperature under load, the specimen was subjected to an annealing treatment for the purpose of eliminating the internal strain of the molded article. The annealing treatment was performed by allowing the specimen to stand still in a hot air dryer at 140° C. for 3 hours.

In the present invention, the case where the deflection temperature under load was 150° C. or higher and had a difference of within 25° C. from the deflection temperature under load of the corresponding base resin composition was evaluated as practically usable.

(4) Bending Elastic Modulus (GPa)

According to ISO 178, a bending test was performed with a 4-mm thick specimen to derive the bending elastic modulus.

(5) Tensile Rupture Elongation (%)

According to ISO 527-1, a tensile test was performed with a 4-mm thick specimen to derive the tensile rupture elongation.

In the present invention, the case where the tensile rupture elongation was 10% or more was evaluated as practically usable.

(6) Charpy Impact Value (J/m²)

According to ISO 179-1eA, a Charpy impact value was measured by using a 4-mm thick specimen with a notch.

In the present invention, the Charpy impact value is preferably 5 kJ/m² or more, more preferably 7 kJ/m² or more and furthermore preferably 10 kJ/m² or more. The case where the Charpy impact value was 5 kJ/m² or more was evaluated as practically usable.

(7) Total Light Transmission (%)

A 2-mm thick plate (molded article) was molded with an injection molding machine (Model EC 100 N, manufactured by Toshiba Machine Co., Ltd.). According to ISO 13468-1, the total light transmission of the plate was measured with a turbidity meter (Model NDH 2000, manufactured by Nippon Denshoku Industries Co., Ltd.) under the conditions that the light source was D65 and the view angle was set at 2°.

In the present invention, the total light transmission is preferably 30% or more and more preferably 40% or more. The case where the total light transmission was 30% or more was determined to have visibility.

(8) Water Absorption Percentage (%)

A plate of 3 mmt in thickness was used as a specimen, and the water absorption percentage was measured according to ISO 62, at an elapsed time of 24 hours in water at 23° C.

(9) Evaluation of Exterior Appearance of Molded Article in Annealing

The plate (molded article) molded in (7) was used as a specimen. The molded article was subjected to an annealing treatment by allowing the molded article to stand still for 2 hours in a hot air dryer controlled at each of the following temperatures, and the exterior appearance of the molded article after the treatment was visually examined. The temperatures for performing the annealing treatment were 130° C., 140° C. and 150° C. The case where the distortion, cracking, rupture or exfoliation of the molded article occurred was determined to have abnormality, and the exterior appearance was determined on the basis of the following evaluation standards.

Excellent (E): The treatment at 150° C. results in no identification of any of the distortion, cracking, rupture and exfoliation of the molded article.

Good (G): The treatment at 150° C. results in identification of at least one of the distortion, cracking, rupture and exfoliation of the molded article. However, the treatment at 140° C. results in no identification of any of the distortion, cracking, rupture and exfoliation of the molded article.

Average (A): The treatment at 140° C. results in identification of at least one of the distortion, cracking, rupture and exfoliation of the molded article. However, the treatment at 130° C. results in no identification of any of the distortion, cracking, rupture and exfoliation of the molded article.

Poor (P): The treatment at 130° C. results in identification of at least one of the distortion, cracking, rupture and exfoliation of the molded article.

(10) Evaluation of Molding Flash

In the molding of the resin compositions obtained in Examples and Comparative Examples into plate-shaped molded articles, the surface of the molded articles were subjected to the following treatment. Specifically, by using a mold subjected to mirror-like finishing with a #8000 abrasive grit, for obtaining a 2-mm thick plate, a molded article was obtained by sufficiently applying a dwelling pressure so as to avoid the formation of sinks. Then, the sizes (unit: μm) of the flashes occurring on the edges of the obtained molded article were measured with an optical microscope.

In the present invention, the evaluation of the molding flash performance preferably involves a comparison between the cases having equal fluidity. Specifically, the evaluation of the molding flash performance was performed by comparing the flash sizes of an Example and a Comparative Example having approximately the same bar flow length as that of concerned Example wherein concerned Comparative Example involves the base resin composition associated with concerned Example.

Because the fluidity improvement effect of the acrylonitrile-styrene copolymer is very high, in the Examples of the present specification, no Comparative Examples may be found, equal in fluidity, involving the base compositions associated with Examples. In such cases, on the basis of a comparison with the most reasonable example (Comparative Example 9) with respect to the fluidity, among the Comparative Examples involving the base resin compositions associated with Examples, the case where the length of the molding flash was reduced as compared to Comparative Example 9 was determined to exhibit a sufficient reduction effect of the molding flash. In the present invention, for example, the length of the molding flash is preferably 150 μm or less and more preferably 100 μm or less.

(11) Evaluation of Adaptability to Vapor Deposition

Aluminum was vapor deposited on the plate-shaped molded article obtained by the method based on the above method (10) of the evaluation of the molding flash. The surface of the obtained plate having been vapor deposited with aluminum was visually examined and it was examined whether or not the surface abnormality occurred around the gate. The evaluation was performed on the basis of the following standards.

Good (G): The molded article acquires a satisfactory mirror surface.

Average (A): Flow marks occur only around the gate, but no abnormality of the mirror surface is found in most part of the molded article.

Poor (P): Flow marks occur around the gate, and additionally, in the whole molded article, some abnormalities of the mirror surface such as fogging and silver-like abnormality occur and the vapor deposition is insufficient.

(12) Residence Stability Test

(12)-1: Retention Rate (%) of Inherent Viscosity

First, the inherent viscosity of the pellet-shaped resin composition before molding was measured. Next, the pellet-shaped resin composition was hot air dried at 120° C. for 8 hours or more. Subsequently, a bar flow test mold of 2 mm in thickness and 20 mm in width was fixed to an injection molding machine (trade name: S2000i-100B, manufactured by FANUC Corp.). The mold temperature was set at 110° C. and the cylinder temperature was set at 340° C., and injection molding was performed by using the pellet-shaped resin composition at an injection pressure of 120 MPa and an injection time of 4 seconds. The molding was repeated for several shots, and a molded article at a stage of stabilized flow length was obtained. Then, the inherent viscosity of the obtained molded article was measured. On the basis of the following formula, the retention rate of the inherent viscosity was derived, and on the basis of the obtained value, the residence stability of the resin composition was evaluated.

Retention rate of inherent viscosity (residence stability)=[(inherent viscosity of molded article)/(inherent viscosity of pellet before molding)]×100

In the present invention, from the viewpoint of the mechanical properties and the exterior appearance of the obtained molded article, the retention rate of the inherent viscosity (residence stability) is preferably 80% or more, more preferably 90% or more and furthermore preferably 95% or more.

(12)-2: Exterior Appearance During Molding (Occurrence of Silver-Like Abnormality)

A molded article was obtained according to the procedure described in foregoing (12)-1, the exterior appearance of the obtained molded article was visually examined and evaluated on the basis of the following standards.

Good (G): No silver-like abnormality occurs on the surface of the molded article.

Poor (P): Silver-like abnormality occurs on the surface of the molded article.

(12)-3: Exterior Appearance During Molding (Yellowing)

A molded article was obtained according to the procedure described in foregoing (12)-1, the exterior appearance of the obtained molded article was visually examined and evaluated on the basis of the following standards.

Good (G): Even when molding is repeated for 10 shots, the color of the molded article is not changed.

Average (A): When molding is repeated for 10 shots, the color of the molded article is changed to be slightly yellowed.

Poor (P): When molding is repeated for 10 shots, the color of the molded article is remarkably changed and yellowing is increased.

(13) Improvement Rate (%) of Bar Flow Length

According to the measurement method described in foregoing (2), bar flow lengths were measured, and the improvement rate of the bar flow length was derived on the basis of the following formula. The improvement rate of the bar flow length is a value representing the degree of variation of the bar flow length due to the inclusion of the acrylonitrile-styrene copolymer (C).

Improvement rate(%) of bar flow length={(bar flow length of obtained resin composition)/(bar flow length of base resin composition)}×100

In the present invention, the improvement rate of the bar flow length measured with a thickness of 2 mmt is preferably 2000 or more and more preferably 230% or more. The improvement rate of the bar flow length measured with a thickness of 1 mmt is preferably 250% or more and more preferably 300% or more. In the present invention, the case where the improvement rate of the bar flow length measured with the thickness of 2 mmt was 200% or more and the improvement rate of the bar flow length measured with the thickness of 1 mmt was 250% or more was determined to be practically usable.

(14) Retention Rate (%) of Bar Flow Length for Thin Wall

According to the measurement method described in foregoing (2), bar flow lengths were measured, and the decrease rate of the bar flow length for thin wall was derived on the basis of the following formula. The decrease rate of the bar flow length for thin wall is a value representing the degree of variation, dependent on the thickness during molding, of the bar flow length due to the inclusion of the acrylonitrile-styrene copolymer (C)

Decrease rate(%) of bar flow length for thin wall=[(1 mmt bar flow length)/(2 mmt bar flow length)]×100

The retention rate of the bar flow length for thin wall means that the larger the numerical value of the retention rate of the bar flow length for thin wall is, the more preferable the concerned rate is, and the smaller the decrease of the fluidity for thin wall is.

(15) Improvement Rate of Fluidity

The value obtained on the basis of the retention rates of the bar flow length for thin wall in (14) and the following formula was defined as the improvement rate of the fluidity.

Improvement rate(%) of fluidity={(retention rate of bar flow length for thin wall of obtained resin composition)−(retention rate of bar flow length for thin wall of base resin composition)}×100

The improvement rate of the fluidity means that the larger the numerical value of the improvement rate of the fluidity is, the higher the fluidity improvement effect due to the fluidity improver is; the improvement rate of the fluidity is preferably 5% or more and more preferably 8% or more.

(16) Retention Rate (%) of Tensile Rupture Elongation

According to the measurement method described in foregoing (5), the tensile rupture elongations were measured, and the retention rate of the tensile rupture elongation was derived on the basis of the following formula. The retention rate of the tensile rupture elongation is a value representing the degree of variation of the tensile rupture elongation due to the inclusion of the acrylonitrile-styrene copolymer (C).

Retention rate(%) of tensile rupture elongation={(tensile rupture elongation of obtained resin composition)/(tensile rupture elongation of base resin composition)}×100

In the present invention, the case where the retention rate of the tensile rupture elongation was 50% or more was determined to be practically usable. The retention rate of the tensile rupture elongation is preferably 65% or more and more preferably 80% or more.

(17) Retention Rate (%) of Charpy Impact Value

According to the measurement method described in foregoing (6), the Charpy impact values were measured, and the retention rate of the Charpy impact value was derived on the basis of the following formula. The retention rate of the Charpy impact value is a value representing the degree of variation of the Charpy impact value due to the inclusion of the acrylonitrile-styrene copolymer (C).

Retention rate(%) of Charpy impact value={(Charpy impact value of obtained resin composition)/(Charpy impact value of base resin composition)}×100

In the present invention, the case where the retention rate of the Charpy impact value was 20% or more was determined to be practically usable. The retention rate of the Charpy impact value is preferably 30% or more and more preferably 40% or more.

(18) Overall Evaluation

The case where the heat resistance (deflection temperature under load), the mechanical property (tensile rupture elongation or Charpy impact value), the optical property (total light transmission) and the improvement rate of the fluidity were satisfactorily balanced and were excellent was determined to be marked with G (Good), and the case where at least any one of these properties was poor was determined to be marked with P (Poor).

In the resin composition of the present invention, the case where the retention rate of the tensile rupture elongation and the retention rate of the Charpy impact value are both excellent is preferable; however, even the case where one of these properties was excellent was determined to be excellent in mechanical properties.

The aforementioned evaluation methods (1) to (18) are the evaluations associated with the problems to be solved by the resin composition of the present invention, namely, the improvement of the visibility, the fluidity and the various mechanical properties.

(19) Electromagnetic Wave Shielding Property

The electromagnetic wave shielding property was evaluated according to a KEC method specified by General Incorporated Association, KEC KANSAI Electronic Industry Development Center in Japan. Specifically, by using an electromagnetic wave shielding effect measurement apparatus developed by General Incorporated Association, KEC KANSAI Electronic Industry Development Center, the electric field strength in the space in the presence of a specimen as a shielding material and the electric filed strength in the space in the absence of the specimen were measured. By using these measurement results, the electric field shielding property was obtained on the basis of the following formula.

Electric field shielding property (dB)=20 log₁₀(E₀/E₁)

wherein E₀ and E₁ represent the following electric field strengths, respectively:

E₀ (v/m): Electric field strength in the space in the absence of the specimen

E₁ (v/m): Electric field strength in the space in the presence of the specimen

As the specimen, a molded article of 150 mm in width, 100 mm in length and 2 mm in thickness was adopted.

The larger the obtained numerical value is, the better the electric field shielding property is. In the present invention, the electric field shielding property is preferably 25 dB or more, more preferably 30 dB or more and particularly preferably 35 dB or more at a frequency of 1 GHz. The case where the electric field shielding property is 25 dB or more is regarded as a case where a practically usable electromagnetic wave shielding effect is achieved.

The aforementioned evaluation method (19) is to be applied to the evaluation of the case where a conductive substance was mixed as an additive in the resin composition to impart the electromagnetic wave shielding property to the resin composition.

Hereinafter, the materials used in Examples and Comparative Examples are described.

Polyarylate Resin (A)

(A-1)

A polyarylate resin including bisphenol A, terephthalic acid and isophthalic acid, and having an inherent viscosity of 0.54 dl/g.

Polycarbonate resins (B)

(B-1)

Trade name “Calibre 200-3” manufactured by Sumitomo Dow Ltd.

A polycarbonate resin having an inherent viscosity of 0.645 dl/g.

(B-2)

Trade name “Calibre 200-30” manufactured by Sumitomo Dow Ltd.

A polycarbonate resin having an inherent viscosity of 0.435 dl/g.

Acrylonitrile-Styrene Copolymers (C)

(C-1)

Trade name “UMG AXS resin S202N” manufactured by UMG ABS, Ltd.

An acrylonitrile-styrene copolymer in which the copolymerization ratio between acrylonitrile and styrene in terms of molar ratio is acrylonitrile/styrene=27/73, having an inherent viscosity of 0.668 dl/g and a weight average molecular weight of 105,000.

(C-2)

Trade name “UMG AXS resin S101N” manufactured by UMG ABS, Ltd.

An acrylonitrile-styrene copolymer in which the copolymerization ratio between acrylonitrile and styrene in terms of molar ratio is acrylonitrile/styrene=22/78, having an inherent viscosity of 0.454 dl/g and a weight average molecular weight of 60,000.

(C-3)

Trade name “UMG AXS resin S402N” manufactured by UMG ABS, Ltd.

An acrylonitrile-styrene copolymer in which the copolymerization ratio between acrylonitrile and styrene in terms of molar ratio is acrylonitrile/styrene=40/60, having an inherent viscosity of 0.588 dl/g and a weight average molecular weight of 110,000.

(C-4)

Trade name “UMG AXS resin S100N” manufactured by UMG ABS, Ltd.

An acrylonitrile-styrene copolymer in which the copolymerization ratio between acrylonitrile and styrene in terms of molar ratio is acrylonitrile/styrene=22/78, having an inherent viscosity of 0.763 dl/g and a weight average molecular weight of 140,000.

(C-5)

Trade name “UMG AXS resin S103N” manufactured by UMG ABS, Ltd.

An acrylonitrile-styrene copolymer in which the copolymerization ratio between acrylonitrile and styrene in terms of molar ratio is acrylonitrile/styrene=20/80, having an inherent viscosity of 0.895 dl/g and a weight average molecular weight of 184,000.

Fluidity Improvers (D) other than Acrylonitrile-Styrene Copolymers (C)

(D-1)

Polystyrene resin

Trade name “Toyo Styrol GP G210C” manufactured by Toyo Styrene Co., Ltd.

(D-2)

Acrylonitrile-butadiene-styrene resin

Trade name “Techno ABS 130” manufactured by Techno Polymer Co., Ltd.

(D-3)

Methyl methacrylate-styrene resin

Trade name “Acrystar KT-80” manufactured by Denki Kagaku Kogyo K.K.

A methyl methacrylate-styrene resin in which the copolymerization ratio between methyl methacrylate and styrene in terms of molar ratio is methyl methacrylate/styrene=90/10.

(D-4)

Cycloolefin-based resin

Trade name “TOPAS 6015” manufactured by Polyplastics Co., Ltd.

A cycloolefin-based resin having a glass transition point of 160° C., composed of ethylene and norbornene, and including norbornene in the structure of the resin in a mass proportion of 79%.

(D-5)

Polyamide 6

A polyamide 6 having a relative viscosity of 2.5, an amino terminal group concentration of 62 mol/ton and a melting point of 220° C., and having no terminal blocking agent added therein during polymerization.

(D-6)

Polyamide 66

Trade name “50 BWFS” manufactured by Solutia Japan Ltd.

A polyamide 66 having a relative viscosity of 2.68, an amino terminal group concentration of 35 mol/ton and a melting point of 260° C.

In the present invention, the relative viscosity can be obtained as follows. Specifically, the relative viscosity can be obtained under the conditions that a mixed solution composed of phenol and 1,1,2,2-tetrachloroethane [phenol/1,1,2,2-tetrachloroethane=60/40 (mass ratio)] is used as a solvent, the measurement temperature is 25° C. and the measurement concentration is 1 g/dl.

In the present invention, the concentration of the amino groups present at the terminals can be obtained specifically under the conditions that a sample is dissolved in m-cresol, and the resulting solution is titrated with p-toluenesulfonic acid on the basis of an ordinary method.

Additives other than Fluidity Improvers

(E-1)

Spherical graphite

Trade name “CGB 50” manufactured by Nippon Graphite Industries, Ltd.; a spherical graphite having an average particle size of 50 μm.

(E-2)

Carbon black

Trade name “#3050B” manufactured by Mitsubishi Chemical Corp.

(E-3)

Carbon fiber

Trade name “HTA-C6-UAL1” manufactured by Toho Tenax Co., Ltd.

(E-4)

Trade name “Passtran Type IV” manufactured by Mitsui Mining & Smelting Co., Ltd.; a powder prepared by coating the surface of barium sulfate with tin oxide and antimony oxide.

(E-5)

Glass fiber

Trade name “CSG 3PA-830” manufactured by Nitto Boseki Co., Ltd.

(E-6)

Phenol-based antioxidant

Trade name “IRGANOX 1010” manufactured by BASF Corp.

(E-7)

Release agent

Trade name “VPG 891” manufactured by Cognis Japan Ltd.

### Example 1

The polyarylate resin (A), the polycarbonate resin (B) and the acrylonitrile-styrene copolymer (C) were dry blended in the content proportions listed in Table 1, with the proviso that the placed total amount was 3 kg. The resulting mixture was fed to the main feed opening of a double screw extruder (trade name: TEM 26SS, manufactured by Toshiba Machine Co., Ltd.) having a vent section and a screw diameter of 26 mm, by using a loss-in-weight type continuous metering feeder (trade name: CE-W-1, manufactured by Kubota Corp.). In the extruder, the fed mixture was melt-kneaded under the conditions that the barrel temperature was set at 320° C., the vent pressure reduction level was set at −0.099 MPa (gauge pressure), the discharge rate was set at 20 kg/h and the screw rotation number was set to 300 rpm. Successively, a resin composition taken up in strands from the die was solidified by cooling in a warm bath vessel, and cut with a pelletizer. The resulting pellets were hot air dried at 120° C. to yield a pellet-shaped resin composition. It is to be noted that in Example 1, the polycarbonate resin (B) was not included.

By using the thus obtained pellet-shaped resin composition, the evaluations were performed on the basis of the aforementioned evaluation methods. The evaluation results thus obtained are shown in Table 1.

In all Examples and Comparative Examples 10 to 18, when the improvement rate of the bar flow length, the improvement rate of the fluidity, the retention rate of the tensile rupture elongation, the retention rate of the Charpy impact value and others were derived, the values of the corresponding properties of the resin compositions (P-1) to (P-8) obtained in Comparative Examples 1 to 8 as the base resin compositions were used.

TABLE 1

| | | | Example | Example | Example | Example | Example | Example | Example | Example | Example |
|---|---|---|---|---|---|---|---|---|---|---|---|
| | | | 1 | 2 | 3 | 4 | 5 | 6 | 7 | 8 | 9 |
| Mixing | Polyarylate | A-1 | 90 | 81 | 72 | 54 | 36 | 27 | 76 | 64 | 56 |
| proportions | resin | | | | | | | | | | |
| (parts by | Poly- | B-1 | 0 | 9 | 18 | 36 | 54 | 63 | 19 | 16 | 14 |
| mass) | carbonate | B-2 | | | | | | | | | |
| | resin | | | | | | | | | | |
| | Acrylonitrile- | C-1 | | | | | | | | | |
| | styrene | C-2 | 10 | 10 | 10 | 10 | 10 | 10 | 5 | 20 | 30 |
| | copolymer | C-3 | | | | | | | | | |
| | | C-4 | | | | | | | | | |
| | | C-5 | | | | | | | | | |
| Mixing | A/B | | 100/0 | 90/10 | 80/20 | 60/40 | 40/60 | 30/70 | 80/20 | 80/20 | 80/20 |
| ratios | C/(A + B + C) | | 10/100 | 10/100 | 10/100 | 10/100 | 10/100 | 10/100 | 5/100 | 20/100 | 30/100 |
| | 1 mmt Bar | mm | 79 | 100 | 114 | 130 | 140 | 145 | 59 | 222 | 300 |
| | flow length | | | | | | | | | | |
| | 2 mmt Bar | mm | 270 | 305 | 330 | 363 | 380 | 390 | 222 | 730 | 920 |
| | flow length | | | | | | | | | | |
| | Deflection | ° C. | 175 | 172 | 169 | 166 | 160 | 153 | 171 | 166 | 156 |
| | temperature | | | | | | | | | | |
| | under load | | | | | | | | | | |
| | Bending | GPa | 2.4 | 2.4 | 2.4 | 2.4 | 2.4 | 2.4 | 2.3 | 2.6 | 2.7 |
| | elastic | | | | | | | | | | |
| | modulus | | | | | | | | | | |
| | Tensile | % | 35 | 49 | 52 | 58 | 75 | 77 | 50 | 78 | 60 |
| | rupture | | | | | | | | | | |
| | elongation | | | | | | | | | | |
| | Charpy | KJ/m² | 16 | 19 | 28 | 34 | 55 | 60 | 27 | 12 | 8 |
| | impact | | | | | | | | | | |
| | value | | | | | | | | | | |
| | Total light | % | 36 | 41 | 43 | 48 | 55 | 61 | 65 | 38 | 32 |
| | transmission | | | | | | | | | | |
| | Water | % | 0.24 | 0.24 | 0.23 | 0.24 | 0.23 | 0.24 | 0.25 | 0.23 | 0.22 |
| | absorption | | | | | | | | | | |
| | percentage | | | | | | | | | | |
| | Exterior | | E | E | E | E | E | E | E | E | E |
| | appearance of | | | | | | | | | | |
| | molded article | | | | | | | | | | |
| | in annealing | | | | | | | | | | |
| | Evaluation | μm | 50 | 60 | 70 | 70 | 80 | 90 | 60 | 90 | 100 |
| | of molding | | | | | | | | | | |
| | flash | | | | | | | | | | |
| | Evaluation of | | G | G | G | G | G | G | G | G | A |
| | adaptability | | | | | | | | | | |
| | to vapor | | | | | | | | | | |
| | deposition | | | | | | | | | | |
| Residence | Retention | % | 95 | 96 | 96 | 97 | 96 | 96 | 97 | 96 | 95 |
| stability | rate of | | | | | | | | | | |
| | inherent | | | | | | | | | | |
| | viscosity | | | | | | | | | | |
| | Exterior | Silver | G | G | G | G | G | G | G | G | G |
| | appearance | Yellow- | G | G | G | G | G | G | G | G | G |
| | during | ing | | | | | | | | | |
| | molding | | | | | | | | | | |
| Evalu- | Base resin | | P-1 | P-2 | P-3 | P-5 | P-6 | P-7 | P-3 | P-3 | P-3 |
| ations | composition as | | | | | | | | | | |
| | standard | | | | | | | | | | |
| | 1 mmt Bar | mm | 79 | 100 | 114 | 130 | 140 | 145 | 59 | 222 | 300 |
| | flow length | | | | | | | | | | |
| | 1 mmt Bar | mm | 10 | 16 | 23 | 34 | 41 | 45 | 23 | 23 | 23 |
| | flow length | | | | | | | | | | |
| | of base resin | | | | | | | | | | |
| | composition | | | | | | | | | | |
| | Improvement | % | 790 | 625 | 496 | 382 | 341 | 322 | 257 | 965 | 1304 |
| | rate of bar | | | | | | | | | | |
| | flow length | | | | | | | | | | |
| | 2 mmt Bar | mm | 270 | 305 | 330 | 363 | 380 | 390 | 222 | 730 | 920 |
| | flow length | | | | | | | | | | |
| | 2 mmt Bar | mm | 55 | 80 | 110 | 140 | 160 | 170 | 110 | 110 | 110 |
| | flow length | | | | | | | | | | |
| | of base resin | | | | | | | | | | |
| | composition | | | | | | | | | | |
| | Improvement | % | 491 | 381 | 300 | 259 | 238 | 229 | 202 | 664 | 836 |
| | rate of bar | | | | | | | | | | |
| | flow length | | | | | | | | | | |
| | Retention | % | 29 | 33 | 35 | 36 | 37 | 37 | 27 | 30 | 33 |
| | rate of bar | | | | | | | | | | |
| | flow length | | | | | | | | | | |
| | for thin wall | | | | | | | | | | |
| | Retention | % | 18 | 20 | 21 | 24 | 26 | 26 | 21 | 21 | 21 |
| | rate of bar | | | | | | | | | | |
| | flow length | | | | | | | | | | |
| | for thin wall | | | | | | | | | | |
| | in base resin | | | | | | | | | | |
| | composition | | | | | | | | | | |
| | Improvement | % | 11 | 13 | 14 | 12 | 11 | 11 | 6 | 9 | 12 |
| | rate of | | | | | | | | | | |
| | fluidity | | | | | | | | | | |
| | Tensile | % | 35 | 49 | 52 | 58 | 75 | 77 | 50 | 78 | 60 |
| | rupture | | | | | | | | | | |
| | elongation | | | | | | | | | | |
| | Tensile | % | 35 | 42 | 58 | 65 | 74 | 50 | 58 | 58 | 58 |
| | rupture | | | | | | | | | | |
| | elongation | | | | | | | | | | |
| | of base resin | | | | | | | | | | |
| | composition | | | | | | | | | | |
| | Retention | % | 100 | 117 | 90 | 89 | 101 | 154 | 86 | 134 | 103 |
| | rate of | | | | | | | | | | |
| | tensile | | | | | | | | | | |
| | rupture | | | | | | | | | | |
| | elongation | | | | | | | | | | |
| | Charpy | KJ/m² | 16 | 19 | 28 | 34 | 55 | 60 | 27 | 9 | 7 |
| | impact | | | | | | | | | | |
| | value | | | | | | | | | | |
| | Charpy | KJ/m² | 19 | 22 | 29 | 38 | 47 | 52 | 29 | 29 | 29 |
| | impact | | | | | | | | | | |
| | value of | | | | | | | | | | |
| | base resin | | | | | | | | | | |
| | composition | | | | | | | | | | |
| | Retention | % | 84 | 86 | 97 | 89 | 117 | 115 | 93 | 31 | 24 |
| | rate of | | | | | | | | | | |
| | Charpy | | | | | | | | | | |
| | impact | | | | | | | | | | |
| | value | | | | | | | | | | |
| Overall evaluation | | | G | G | G | G | G | G | G | G | G |
| | | | Example | Example | Example | Example | Example | Example | Example | Example | Example |
| | | | 10 | 11 | 12 | 13 | 14 | 15 | 16 | 17 | 18 |
| Mixing | Polyarylate | A-1 | 70 | 63 | 72 | 64 | 56 | 72 | 72 | 72 | 72 |
| proportions | resin | | | | | | | | | | |
| (parts by | Poly- | B-1 | | 7 | | | | 18 | 18 | 18 | 18 |
| mass) | carbonate | B-2 | | | 18 | 16 | 14 | | | | |
| | resin | | | | | | | | | | |
| | Acrylonitrile- | C-1 | | | | | | 10 | | | |
| | styrene | C-2 | 30 | 30 | 10 | 20 | 30 | | | | |
| | copolymer | C-3 | | | | | | | 10 | | |
| | | C-4 | | | | | | | | 10 | |
| | | C-5 | | | | | | | | | 10 |
| Mixing | A/B | | 100/0 | 90/10 | 80/20 | 80/20 | 80/20 | 80/20 | 80/20 | 80/20 | 80/20 |
| ratios | C/(A + B + C) | | 30/100 | 30/100 | 10/100 | 20/100 | 30/100 | 10/100 | 10/100 | 10/100 | 10/100 |
| | 1 mmt Bar | mm | 250 | 275 | 130 | 240 | 312 | 95 | 100 | 90 | 82 |
| | flow length | | | | | | | | | | |
| | 2 mmt Bar | mm | 780 | 840 | 360 | 760 | 930 | 270 | 250 | 255 | 230 |
| | flow length | | | | | | | | | | |
| | Deflection | ° C. | 161 | 158 | 166 | 163 | 154 | 169 | 167 | 168 | 168 |
| | temperature | | | | | | | | | | |
| | under load | | | | | | | | | | |
| | Bending | GPa | 2.7 | 2.7 | 2.4 | 2.6 | 2.7 | 2.4 | 2.4 | 2.4 | 2.4 |
| | elastic | | | | | | | | | | |
| | modulus | | | | | | | | | | |
| | Tensile | % | 19 | 27 | 37 | 30 | 28 | 52 | 36 | 64 | 62 |
| | rupture | | | | | | | | | | |
| | elongation | | | | | | | | | | |
| | Charpy | KJ/m² | 5 | 6 | 20 | 10 | 5 | 25 | 18 | 26 | 25 |
| | impact | | | | | | | | | | |
| | value | | | | | | | | | | |
| | Total light | % | 30 | 31 | 47 | 42 | 38 | 40 | 38 | 45 | 47 |
| | transmission | | | | | | | | | | |
| | Water | % | 0.22 | 0.22 | 0.25 | 0.24 | 0.22 | 0.25 | 0.24 | 0.24 | 0.24 |
| | absorption | | | | | | | | | | |
| | percentage | | | | | | | | | | |
| | Exterior | | E | E | E | E | E | E | G | E | E |
| | appearance of | | | | | | | | | | |
| | molded article | | | | | | | | | | |
| | in annealing | | | | | | | | | | |
| | Evaluation | μm | 100 | 100 | 80 | 90 | 100 | 100 | 130 | 80 | 90 |
| | of molding | | | | | | | | | | |
| | flash | | | | | | | | | | |
| | Evaluation of | | A | A | G | G | G | G | A | G | G |
| | adaptability | | | | | | | | | | |
| | to vapor | | | | | | | | | | |
| | deposition | | | | | | | | | | |
| Residence | Retention | % | 92 | 94 | 97 | 96 | 96 | 96 | 88 | 96 | 96 |
| stability | rate of | | | | | | | | | | |
| | inherent | | | | | | | | | | |
| | viscosity | | | | | | | | | | |
| | Exterior | Silver | G | G | G | G | G | G | G | G | G |
| | appearance | Yellow- | G | G | G | G | G | G | A | G | G |
| | during | ing | | | | | | | | | |
| | molding | | | | | | | | | | |
| Evalu- | Base resin | | P-1 | P-2 | P-4 | P-4 | P-4 | P-3 | P-3 | P-3 | P-3 |
| ations | composition as | | | | | | | | | | |
| | standard | | | | | | | | | | |
| | 1 mmt Bar | mm | 250 | 275 | 130 | 240 | 312 | 95 | 100 | 90 | 85 |
| | flow length | | | | | | | | | | |
| | 1 mmt Bar | mm | 10 | 16 | 28 | 28 | 28 | 23 | 23 | 23 | 23 |
| | flow length | | | | | | | | | | |
| | of base resin | | | | | | | | | | |
| | composition | | | | | | | | | | |
| | Improvement | % | 2500 | 1719 | 464 | 857 | 1114 | 413 | 435 | 391 | 370 |
| | rate of bar | | | | | | | | | | |
| | flow length | | | | | | | | | | |
| | 2 mmt Bar | mm | 780 | 840 | 360 | 760 | 930 | 270 | 250 | 255 | 230 |
| | flow length | | | | | | | | | | |
| | 2 mmt Bar | mm | 55 | 80 | 125 | 125 | 125 | 110 | 110 | 110 | 110 |
| | flow length | | | | | | | | | | |
| | of base resin | | | | | | | | | | |
| | composition | | | | | | | | | | |
| | Improvement | % | 1418 | 1050 | 288 | 608 | 744 | 245 | 227 | 232 | 209 |
| | rate of bar | | | | | | | | | | |
| | flow length | | | | | | | | | | |
| | Retention | % | 32 | 33 | 36 | 32 | 34 | 35 | 40 | 35 | 37 |
| | rate of bar | | | | | | | | | | |
| | flow length | | | | | | | | | | |
| | for thin wall | | | | | | | | | | |
| | Retention | % | 18 | 20 | 22 | 22 | 22 | 21 | 21 | 21 | 21 |
| | rate of bar | | | | | | | | | | |
| | flow length | | | | | | | | | | |
| | for thin wall | | | | | | | | | | |
| | in base resin | | | | | | | | | | |
| | composition | | | | | | | | | | |
| | Improvement | % | 14 | 13 | 14 | 10 | 12 | 14 | 19 | 14 | 16 |
| | rate of | | | | | | | | | | |
| | fluidity | | | | | | | | | | |
| | Tensile | % | 19 | 32 | 37 | 30 | 28 | 52 | 36 | 64 | 62 |
| | rupture | | | | | | | | | | |
| | elongation | | | | | | | | | | |
| | Tensile | % | 35 | 42 | 32 | 32 | 32 | 58 | 58 | 58 | 58 |
| | rupture | | | | | | | | | | |
| | elongation | | | | | | | | | | |
| | of base resin | | | | | | | | | | |
| | composition | | | | | | | | | | |
| | Retention | % | 54 | 76 | 116 | 94 | 88 | 90 | 62 | 110 | 107 |
| | rate of | | | | | | | | | | |
| | tensile | | | | | | | | | | |
| | rupture | | | | | | | | | | |
| | elongation | | | | | | | | | | |
| | Charpy | KJ/m² | 5 | 6 | 20 | 9 | 5 | 25 | 18 | 26 | 25 |
| | impact | | | | | | | | | | |
| | value | | | | | | | | | | |
| | Charpy | KJ/m² | 19 | 22 | 21 | 21 | 21 | 29 | 29 | 29 | 29 |
| | impact | | | | | | | | | | |
| | value of | | | | | | | | | | |
| | base resin | | | | | | | | | | |
| | composition | | | | | | | | | | |
| | Retention | % | 26 | 27 | 95 | 43 | 24 | 86 | 62 | 90 | 86 |
| | rate of | | | | | | | | | | |
| | Charpy | | | | | | | | | | |
| | impact | | | | | | | | | | |
| | value | | | | | | | | | | |

| | | | | | | | | | |
|---|---|---|---|---|---|---|---|---|---|
| Overall evaluation | G | G | G | G | G | G | G | G | G |

### Examples 2 to 18

In each of Examples 2 to 18, pellets of a resin composition were obtained in the same manner as in Example 1 except that the composition shown in Table 1 was adopted, and the obtained resin composition was evaluated. The obtained evaluation results are shown in Table 1.

### Comparative Examples 1 to 18

In each of Comparative Examples 1 to 18, pellets of a resin composition were obtained in the same manner as in Example 1 except that the composition shown in Table 2 was adopted, and the obtained resin composition was evaluated. The obtained evaluation results are shown in Table 2.

TABLE 2

| | | | Compar- | Compar- | Compar- | Compar- | Compar- | Compar- | Compar- | Compar- | Compar- |
|---|---|---|---|---|---|---|---|---|---|---|---|
| | | | ative | ative | ative | ative | ative | ative | ative | ative | ative |
| | | | Example | Example | Example | Example | Example | Example | Example | Example | Example |
| | | | 1 | 2 | 3 | 4 | 5 | 6 | 7 | 8 | 9 |
| | | | P-1 | P-2 | P-3 | P-4 | P-5 | P-6 | P-7 | P-8 | P-9 |
| Mixing | Polyarylate | A-1 | 100 | 90 | 80 | 80 | 60 | 40 | 30 | 20 | 30 |
| proportions | resin | | | | | | | | | | |
| (parts by | Poly- | B-1 | | 10 | 20 | | 40 | 60 | 70 | 80 | |
| mass) | carbonate | B-2 | | | | 20 | | | | | 70 |
| | resin | | | | | | | | | | |
| | Acrylonitrile- | C-2 | | | | | | | | | |
| | styrene | | | | | | | | | | |
| | copolymer | | | | | | | | | | |
| | Other | D-1 | | | | | | | | | |
| | fluidity | D-2 | | | | | | | | | |
| | improvers | D-3 | | | | | | | | | |
| | | D-4 | | | | | | | | | |
| | | D-5 | | | | | | | | | |
| | | D-6 | | | | | | | | | |
| Mixing | A/B | | 100/0 | 90/10 | 80/20 | 80/20 | 60/40 | 40/60 | 30/70 | 20/80 | 30/70 |
| ratios | C/(A + B + C) | | 0/100 | 0/100 | 0/100 | 0/100 | 0/100 | 0/100 | 0/100 | 0/100 | 0/100 |
| | 1 mmt Bar | mm | 10 | 16 | 23 | 28 | 34 | 41 | 45 | 47 | 76 |
| | flow length | | | | | | | | | | |
| | 2 mmt Bar | mm | 55 | 80 | 110 | 125 | 140 | 160 | 170 | 175 | 260 |
| | flow length | | | | | | | | | | |
| | Deflection | ° C. | 177 | 174 | 172 | 167 | 168 | 161 | 155 | 153 | 152 |
| | temperature | | | | | | | | | | |
| | under load | | | | | | | | | | |
| | Bending | GPa | 2.1 | 2.1 | 2.1 | 2.2 | 2.1 | 2.2 | 2.2 | 2.2 | 2.2 |
| | elastic | | | | | | | | | | |
| | modulus | | | | | | | | | | |
| | Tensile | % | 35 | 42 | 58 | 32 | 65 | 74 | 50 | 66 | 50 |
| | rupture | | | | | | | | | | |
| | elongation | | | | | | | | | | |
| | Charpy | KJ/m² | 19 | 22 | 29 | 21 | 38 | 47 | 52 | 70 | 40 |
| | impact | | | | | | | | | | |
| | value | | | | | | | | | | |
| | Total light | % | 88 | 89 | 89 | 89 | 89 | 89 | 89 | 89 | 89 |
| | transmission | | | | | | | | | | |
| | Water | % | 0.26 | 0.26 | 0.26 | 0.26 | 0.26 | 0.25 | 0.25 | 0.25 | 0.26 |
| | absorption | | | | | | | | | | |
| | percentage | | | | | | | | | | |
| | Exterior | | E | E | E | E | E | E | E | E | E |
| | appearance of | | | | | | | | | | |
| | molded article | | | | | | | | | | |
| | in annealing | | | | | | | | | | |
| | Evaluation | μm | 50 | 60 | 60 | 120 | 120 | 140 | 160 | 150 | 270 |
| | of molding | | | | | | | | | | |
| | flash | | | | | | | | | | |
| | Evaluation of | | G | G | G | G | G | G | G | G | G |
| | adaptability | | | | | | | | | | |
| | to vapor | | | | | | | | | | |
| | deposition | | | | | | | | | | |
| Residence | Retention | % | 96 | 97 | 98 | 96 | 98 | 97 | 97 | 97 | 97 |
| stability | rate of | | | | | | | | | | |
| | inherent | | | | | | | | | | |
| | viscosity | | | | | | | | | | |
| | Exterior | Silver | G | G | G | G | G | G | G | G | G |
| | appearance | Yellow- | G | G | G | G | G | G | G | G | G |
| | during | ing | | | | | | | | | |
| | molding | | | | | | | | | | |
| Evalu- | Base resin | | — | — | — | — | — | — | — | — | — |
| ations | composition as | | | | | | | | | | |
| | standard | | | | | | | | | | |
| | 1 mmt Bar | mm | 10 | 16 | 23 | 28 | 34 | 41 | 45 | 47 | 76 |
| | flow length | | | | | | | | | | |
| | 1 mmt Bar | mm | — | — | — | — | — | — | — | — | — |
| | flow length | | | | | | | | | | |
| | of base resin | | | | | | | | | | |
| | composition | | | | | | | | | | |
| | Improvement | % | — | — | — | — | — | — | — | — | — |
| | rate of bar | | | | | | | | | | |
| | flow length | | | | | | | | | | |
| | 2 mmt Bar | mm | 55 | 80 | 110 | 125 | 140 | 160 | 170 | 175 | 260 |
| | flow length | | | | | | | | | | |
| | 2 mmt Bar | mm | — | — | — | — | — | — | — | — | — |
| | flow length | | | | | | | | | | |
| | of base resin | | | | | | | | | | |
| | composition | | | | | | | | | | |
| | Improvement | % | — | — | — | — | — | — | — | — | — |
| | rate of bar | | | | | | | | | | |
| | flow length | | | | | | | | | | |
| | Retention | % | 18 | 20 | 21 | 22 | 24 | 26 | 26 | 27 | 29 |
| | rate of bar | | | | | | | | | | |
| | flow length | | | | | | | | | | |
| | for thin wall | | | | | | | | | | |
| | Retention | % | — | — | — | — | — | — | — | — | — |
| | rate of bar | | | | | | | | | | |
| | flow length | | | | | | | | | | |
| | for thin wall | | | | | | | | | | |
| | in base resin | | | | | | | | | | |
| | composition | | | | | | | | | | |
| | Improvement | % | — | — | — | — | — | — | — | — | — |
| | rate of | | | | | | | | | | |
| | fluidity | | | | | | | | | | |
| | Tensile | % | 35 | 42 | 58 | 32 | 65 | 74 | 50 | 66 | 50 |
| | rupture | | | | | | | | | | |
| | elongation | | | | | | | | | | |
| | Tensile | % | — | — | — | — | — | — | — | — | — |
| | rupture | | | | | | | | | | |
| | elongation | | | | | | | | | | |
| | of base resin | | | | | | | | | | |
| | composition | | | | | | | | | | |
| | Retention | % | — | — | — | — | — | — | — | — | — |
| | rate of | | | | | | | | | | |
| | tensile | | | | | | | | | | |
| | rupture | | | | | | | | | | |
| | elongation | | | | | | | | | | |
| | Charpy | KJ/m² | 19 | 22 | 29 | 21 | 38 | 47 | 52 | 70 | 40 |
| | impact | | | | | | | | | | |
| | value | | | | | | | | | | |
| | Charpy | KJ/m² | — | — | — | — | — | — | — | — | — |
| | impact | | | | | | | | | | |
| | value of | | | | | | | | | | |
| | base resin | | | | | | | | | | |
| | composition | | | | | | | | | | |
| | Retention | % | — | — | — | — | — | — | — | — | — |
| | rate of | | | | | | | | | | |
| | Charpy | | | | | | | | | | |
| | impact | | | | | | | | | | |
| | value | | | | | | | | | | |
| Overall evaluation | | | P | P | P | P | P | P | P | P | P |
| | | | Compar- | Compar- | Compar- | Compar- | Compar- | Compar- | Compar- | Compar- | Compar- |
| | | | ative | ative | ative | ative | ative | ative | ative | ative | ative |
| | | | Example | Example | Example | Example | Example | Example | Example | Example | Example |
| | | | 10 | 11 | 12 | 13 | 14 | 15 | 16 | 17 | 18 |
| Mixing | Polyarylate | A-1 | 18 | 78 | 52 | 64 | 64 | 64 | 64 | 64 | 64 |
| proportions | resin | | | | | | | | | | |
| (parts by | Poly- | B-1 | 72 | 19.5 | 13 | 16 | 16 | 16 | 16 | 16 | 16 |
| mass) | carbonate | B-2 | | | | | | | | | |
| | resin | | | | | | | | | | |
| | Acrylonitrile- | C-2 | 10 | 4 | 35 | | | | | | |
| | styrene | | | | | | | | | | |
| | copolymer | | | | | | | | | | |
| | Other | D-1 | | | | 10 | | | | | |
| | fluidity | D-2 | | | | | 10 | | | | |
| | improvers | D-3 | | | | | | 10 | | | |
| | | D-4 | | | | | | | 10 | | |
| | | D-5 | | | | | | | | 10 | |
| | | D-6 | | | | | | | | | 10 |
| Mixing | A/B | | 20/80 | 80/20 | 80/20 | 80/20 | 80/20 | 80/20 | 80/20 | 80/20 | 80/20 |
| ratios | C/(A + B + C) | | 10/100 | 4/100 | 35/100 | 10/100 | 10/100 | 10/100 | 10/100 | 10/100 | 10/100 |
| | 1 mmt Bar | mm | 149 | 45 | 330 | 83 | 60 | 78 | 42 | 80 | 85 |
| | flow length | | | | | | | | | | |
| | 2 mmt Bar | mm | 400 | 190 | 980 | 235 | 178 | 229 | 190 | 280 | 310 |
| | flow length | | | | | | | | | | |
| | Deflection | ° C. | 149 | 171 | 148 | 167 | 168 | 169 | 170 | 168 | 168 |
| | temperature | | | | | | | | | | |
| | under load | | | | | | | | | | |
| | Bending | GPa | 2.4 | 2.3 | 2.7 | 2.4 | 2.3 | 2.4 | 2.3 | 2.4 | 2.4 |
| | elastic | | | | | | | | | | |
| | modulus | | | | | | | | | | |
| | Tensile | % | 60 | 55 | 45 | 30 | 50 | 55 | 10 | 51 | 42 |
| | rupture | | | | | | | | | | |
| | elongation | | | | | | | | | | |
| | Charpy | KJ/m² | 65 | 32 | 4 | 26 | 28 | 26 | 28 | 28 | 29 |
| | impact | | | | | | | | | | |
| | value | | | | | | | | | | |
| | Total light | % | 66 | 68 | 29 | 65 | 16 | 45 | 15 | 28 | 22 |
| | transmission | | | | | | | | | | |
| | Water | % | 0.24 | 0.25 | 0.21 | 0.25 | 0.23 | 0.25 | 0.21 | 0.32 | 0.34 |
| | absorption | | | | | | | | | | |
| | percentage | | | | | | | | | | |
| | Exterior | | E | E | G | P | E | E | E | E | E |
| | appearance of | | | | | | | | | | |
| | molded article | | | | | | | | | | |
| | in annealing | | | | | | | | | | |
| | Evaluation | μm | 150 | 70 | 130 | 90 | 120 | 90 | 110 | 180 | 190 |
| | of molding | | | | | | | | | | |
| | flash | | | | | | | | | | |
| | Evaluation of | | G | G | A | G | G | G | G | P | P |
| | adaptability | | | | | | | | | | |
| | to vapor | | | | | | | | | | |
| | deposition | | | | | | | | | | |
| Residence | Retention | % | 96 | 97 | 95 | 96 | 83 | 95 | 92 | 78 | 82 |
| stability | rate of | | | | | | | | | | |
| | inherent | | | | | | | | | | |
| | viscosity | | | | | | | | | | |
| | Exterior | Silver | G | G | G | G | P | G | G | P | P |
| | appearance | Yellow- | G | G | A | G | P | G | G | A | A |
| | during | ing | | | | | | | | | |
| | molding | | | | | | | | | | |
| Evalu- | Base resin | | P-8 | P-3 | P-3 | P-3 | P-3 | P-3 | P-3 | P-3 | P-3 |
| ations | composition as | | | | | | | | | | |
| | standard | | | | | | | | | | |
| | 1 mmt Bar | mm | 149 | 45 | 330 | 83 | 60 | 78 | 42 | 80 | 85 |
| | flow length | | | | | | | | | | |
| | 1 mmt Bar | mm | 47 | 23 | 23 | 23 | 23 | 23 | 23 | 23 | 23 |
| | flow length | | | | | | | | | | |
| | of base resin | | | | | | | | | | |
| | composition | | | | | | | | | | |
| | Improvement | % | 317 | 196 | 1435 | 361 | 261 | 339 | 183 | 348 | 370 |
| | rate of bar | | | | | | | | | | |
| | flow length | | | | | | | | | | |
| | 2 mmt Bar | mm | 400 | 190 | 980 | 235 | 178 | 229 | 190 | 280 | 310 |
| | flow length | | | | | | | | | | |
| | 2 mmt Bar | mm | 175 | 110 | 110 | 110 | 110 | 110 | 110 | 110 | 110 |
| | flow length | | | | | | | | | | |
| | of base resin | | | | | | | | | | |
| | composition | | | | | | | | | | |
| | Improvement | % | 229 | 173 | 891 | 214 | 162 | 208 | 173 | 255 | 282 |
| | rate of bar | | | | | | | | | | |
| | flow length | | | | | | | | | | |
| | Retention | % | 37 | 24 | 34 | 35 | 34 | 34 | 22 | 29 | 27 |
| | rate of bar | | | | | | | | | | |
| | flow length | | | | | | | | | | |
| | for thin wall | | | | | | | | | | |
| | Retention | % | 27 | 21 | 21 | 21 | 21 | 21 | 21 | 21 | 21 |
| | rate of bar | | | | | | | | | | |
| | flow length | | | | | | | | | | |
| | for thin wall | | | | | | | | | | |
| | in base resin | | | | | | | | | | |
| | composition | | | | | | | | | | |
| | Improvement | % | 10 | 3 | 13 | 14 | 13 | 13 | 1 | 8 | 6 |
| | rate of | | | | | | | | | | |
| | fluidity | | | | | | | | | | |
| | Tensile | % | 60 | 55 | 45 | 30 | 50 | 55 | 10 | 51 | 42 |
| | rupture | | | | | | | | | | |
| | elongation | | | | | | | | | | |
| | Tensile | % | 66 | 58 | 58 | 58 | 58 | 58 | 58 | 58 | 58 |
| | rupture | | | | | | | | | | |
| | elongation | | | | | | | | | | |
| | of base resin | | | | | | | | | | |
| | composition | | | | | | | | | | |
| | Retention | % | 91 | 95 | 78 | 52 | 86 | 95 | 17 | 88 | 72 |
| | rate of | | | | | | | | | | |
| | tensile | | | | | | | | | | |
| | rupture | | | | | | | | | | |
| | elongation | | | | | | | | | | |
| | Charpy | KJ/m² | 65 | 32 | 4 | 26 | 28 | 26 | 28 | 28 | 29 |
| | impact | | | | | | | | | | |
| | value | | | | | | | | | | |
| | Charpy | KJ/m² | 70 | 29 | 29 | 29 | 29 | 29 | 29 | 29 | 29 |
| | impact | | | | | | | | | | |
| | value of | | | | | | | | | | |
| | base resin | | | | | | | | | | |
| | composition | | | | | | | | | | |
| | Retention | % | 93 | 110 | 14 | 90 | 97 | 90 | 97 | 97 | 100 |
| | rate of | | | | | | | | | | |
| | Charpy | | | | | | | | | | |
| | impact | | | | | | | | | | |
| | value | | | | | | | | | | |

| | | | | | | | | | |
|---|---|---|---|---|---|---|---|---|---|
| Overall evaluation | P | P | P | P | P | P | P | P | P |

### Examples 19 to 22 and Comparative Examples 19 to 22

In each of Examples 19 to 22 and Comparative Examples 19 to 22, the polyarylate resin (A), the polycarbonate resin (B) and the acrylonitrile-styrene copolymer (C), and one or none of the spherical graphite, the carbon black and the powder prepared by coating the surface of barium sulfate with tin oxide and antimony oxide were dry blended in the mixing proportions listed in Table 3; then, the resulting mixture was melt-kneaded by performing the same operations as in Example 1; both, one or none of the carbon fiber and the glass fiber was fed through a side feeder, midway through the melt kneading so as to meet the composition shown in Table 3. By using the thus obtained pellet-shaped resin compositions, the evaluations were performed on the basis of the aforementioned evaluation methods. The evaluation results thus obtained are shown in Table 3.

TABLE 3

| | | | | | | | Compar- | Compar- | Compar- | Compar- |
|---|---|---|---|---|---|---|---|---|---|---|
| | | | | | | | ative | ative | ative | ative |
| | | | Example | Example | Example | Example | Example | Example | Example | Example |
| | | | 19 | 20 | 21 | 22 | 19 | 20 | 21 | 22 |
| Mixing | Polyarylate | A-1 | 27 | 24 | 21 | 27 | 30 | 30 | 30 | 30 |
| proportions | resin | | | | | | | | | |
| (parts by | Poly- | B-1 | | 56 | 49 | 63 | | | 70 | 70 |
| mass) | carbonate | B-2 | 63 | | | | 70 | 70 | | |
| | resin | | | | | | | | | |
| | Acrylonitrile- | C-1 | 10 | 20 | 30 | 10 | | | | |
| | styrene | | | | | | | | | |
| | copolymer | | | | | | | | | |
| | Additives other | E-1 | | 50 | | | | 50 | | |
| | than fluidity | E-2 | 20 | | | | 20 | | | |
| | improver | E-3 | 30 | | 50 | | 30 | | 50 | |
| | | E-4 | | | | 10 | | | | 10 |
| | | E-5 | 15 | 15 | 15 | | 15 | 15 | 15 | |
| | | E-6 | 0.01 | 0.01 | 0.01 | 0.01 | 0.01 | 0.01 | 0.01 | 0.01 |
| | | E-7 | 0.2 | 0.2 | 0.2 | 0.2 | 0.2 | 0.2 | 0.2 | 0.2 |
| Mixing | A/B | | 30/70 | 30/70 | 30/70 | 30/70 | 30/70 | 30/70 | 30/70 | 30/70 |
| ratios | C/(A + B + C) | | 10/100 | 20/100 | 30/100 | 10/100 | 0/100 | 0/100 | 0/100 | 0/100 |
| Evalu- | 1 mmt Bar | mm | 55 | 73 | 100 | 200 | 50 | 60 | 80 | 180 |
| ations | flow length | | | | | | | | | |
| | 2 mmt Bar | mm | 165 | 219 | 300 | 450 | 150 | 195 | 250 | 400 |
| | flow length | | | | | | | | | |
| | Deflection | ° C. | 147 | 144 | 145 | 145 | 149 | 149 | 151 | 148 |
| | temperature | | | | | | | | | |
| | under load | | | | | | | | | |
| | Bending elastic | GPa | 19.3 | 5.3 | 22 | 2.7 | 19.5 | 5.6 | 22 | 2.8 |
| | modulus | | | | | | | | | |
| | Tensile rupture | % | 3 | 3 | 3 | 3 | 3 | 3 | 3 | 3 |
| | elongation | | | | | | | | | |
| | Charpy | KJ/m² | 6 | 5 | 7 | 7 | 6 | 5 | 7 | 7 |
| | impact value | | | | | | | | | |
| | Total light | % | 0 | 0 | 0 | 34 | 0 | 0 | 0 | 38 |
| | transmission | | | | | | | | | |
| | Electromagnetic | dB | 39.0 | 27.0 | 28.0 | 26.0 | 37.6 | 25.8 | 26.2 | 23.2 |
| | wave shielding | | | | | | | | | |
| | property | | | | | | | | | |
| | (1 GHz) | | | | | | | | | |

As can be seen from Table 1, the resin compositions obtained in Examples 1 to 6, 8, 12, 13, 15 and 17 were excellent in heat resistance, mechanical properties, thickness dependence during molding, residence stability during molding and water absorption property. Moreover, these resin compositions had visibility and were reduced in the occurrence of molding flash. These resin compositions were also excellent in both of the bar flow length and the improvement rate of the fluidity, namely, in the moldability (fluidity).

The resin compositions obtained in Examples 19 to 22 included one or more conductive substances. Accordingly, it was possible to obtain the resin compositions in which the properties such as the electromagnetic wave shielding property were improved while the fluidity was being ensured.

In particular, the resin composition obtained in Example 22 included as the conductive substance the powder prepared by coating the surface of barium sulfate with tin oxide and antimony oxide, and accordingly this resin composition even had visibility.

In the resin compositions obtained in Comparative Examples 1 to 9, the acrylonitrile-styrene copolymer (C) was not mixed. Accordingly, these resin compositions each had a low bar flow length value and were poor in moldability (fluidity).

In the resin composition obtained in Comparative Example 10, the mixing amount of the polyarylate resin (A) was too small. Accordingly, this resin composition resulted in a deflection temperature under load of lower than 150° C., and was poor in heat resistance.

In the resin composition obtained in Comparative Example 11, the mixing amount of the acrylonitrile-styrene copolymer (C) was too small. Accordingly, this resin composition resulted in a low improvement rate of the bar flow length and a low improvement rate of the fluidity. In other words, this resin composition did not developed sufficient moldability (fluidity).

In the resin composition obtained in Comparative Example 12, the mixing amount of the acrylonitrile-styrene copolymer (C) was too large. Accordingly, this resin composition resulted in no problems with respect to the moldability (fluidity), bending property and exterior appearance, but was poor in heat resistance. Additionally, this resin composition resulted in a low Charpy impact value and a low value of the retention rate of the Charpy impact value, that is to say, resulted in poor mechanical properties. In this resin composition, molding flash tended to occur.

In the resin composition obtained in Comparative Example 13, a fluidity improver composed only of styrene was used. Accordingly, exfoliation occurred during the annealing treatment, and thus this resin composition was not suitable for practical use.

In the resin composition obtained in Comparative Example 14, an acrylonitrile-butadiene-styrene resin containing butadiene, a rubber component was used as the fluidity improver. Accordingly, this resin composition was low in the retention rate of the inherent viscosity, and was also degraded in the exterior appearance during molding. In other words, this resin composition had an insufficient residence stability. Additionally, this resin composition exhibited a low total light transmission and was poor in visibility.

In the resin composition obtained in Comparative Example 15, a methyl methacrylate-styrene copolymer was used as the fluidity improver. Accordingly, this resin composition was excellent with respect to the overall balance, but was poor in the fluidity improvement effect.

In the resin composition obtained in Comparative Example 16, a cycloolefin-based resin was used as the fluidity improver. Accordingly, this resin composition was degraded in the total light transmission and was poor in visibility. Additionally, this resin composition had a low bar flow length (1 mmt) and a low improvement rate of the fluidity; in other words, the moldability (fluidity) of this resin composition was degraded. Moreover, this resin composition had a low tensile rupture elongation and a low retention rate of the tensile rupture elongation; in other words, this resin composition was poor in mechanical properties.

In each of the resin compositions obtained in Comparative Examples 17 and 18, a polyamide resin was used as the fluidity improver. Accordingly, these resin compositions each had a degraded total light transmission and were poor in visibility. Additionally, these resin compositions were poor in the residence stability and in the exterior appearance during molding.

In each of the resin compositions obtained in Comparative Examples 19 to 22, the acrylonitrile-styrene copolymer (C) as the fluidity improver was not used. Accordingly, Comparative Examples 19 to 22 were poorer in the moldability (fluidity) as compared to Examples 19 to 22. Additionally, Comparative Examples 19 to 22 were also slightly poorer in the electromagnetic wave shielding property as compared to Examples 19 to 22. Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. A resin composition comprising a polyarylate resin (A), a polycarbonate resin (B) and an acrylonitrile-styrene copolymer (C), wherein mass proportions of components simultaneously satisfy the following condition (I) and the following formula (II):
a mass proportion of (A) is 30% by mass or more (I);
(C)/[(A)+(B)+(C)]=5/100 to 30/100 (II).

2. A resin composition comprising a polyarylate resin (A) and a acrylonitrile-styrene copolymer (C), wherein the mass proportions of the components satisfy the following formula (III):
(C)/[(A)+(C)]=5/100 to 30/100 (III).

3. The resin composition according to claim 1, a copolymerization ratio of the acrylonitrile-styrene copolymer (C) falls in terms of molar ratio within a range of acrylonitrile/styrene=15/85 to 35/65.

4. The resin composition according to claim 1, wherein an inherent viscosity of the polycarbonate resin (B) is 0.3 to 0.7 dl/g.

5. The resin composition according to claim 1, wherein an inherent viscosity of the acrylonitrile-styrene copolymer (C) is 0.4 to 1.0 dl/g.

6. The resin composition according to claim 1, further comprising a conductive substance.

7. The resin composition according to claim 2, a copolymerization ratio of the acrylonitrile-styrene copolymer (C) falls in terms of molar ratio within a range of acrylonitrile/styrene=15/85 to 35/65.

8. The resin composition according to claim 3, wherein an inherent viscosity of the polycarbonate resin (B) is 0.3 to 0.7 dl/g.

9. The resin composition according to claim 2, wherein an inherent viscosity of the acrylonitrile-styrene copolymer (C) is 0.4 to 1.0 dl/g.

10. The resin composition according to claim 2, further comprising a conductive substance.

11. A molded article comprising the resin composition according to claim 1.

12. A molded article comprising the resin composition according to claim 2.
